(19) United States
(12) Patent Application Publication
(10) Pub. No.: US 2013/0167882 A1
(43) Pub. Date: Jul. 4, 2013

(54) POLYMER TREATMENT METHOD

(71) Applicants: Stephen Martin Burkinshaw, West Yorkshire (GB); Stephen Derek Jenkins, Cleveland (GB); Frazer John Kennedy, South Yorkshire (GB); John Edward Steele, West Yorkshire (GB)

(72) Inventors: Stephen Martin Burkinshaw, West Yorkshire (GB); Stephen Derek Jenkins, Cleveland (GB); Frazer John Kennedy, South Yorkshire (GB); John Edward Steele, West Yorkshire (GB)

(73) Assignee: XEROS LIMITED, SOUTH YORKSHIRE (GB)

(21) Appl. No.: 13/822,324

(22) PCT Filed: Sep. 14, 2011
(86) PCT No.: PCT/GB11/51726

§ 371 Date: Mar. 12, 2013

(30) Foreign Application Priority Data
Sep. 14, 2010 (GB) 1015276.7

(51) Int. Cl. C11D 3/43; C11D 1/83; C11D 3/39

(52) U.S. Cl. CPC C11D 3/43; C11D 3/394; C11D 1/83
USPC 134/34; 8/137; 510/244; 525/437

(57) ABSTRACT

The invention provides a method for the treatment of polymeric particles recovered after use in cleaning processes for soiled substrates, the method comprising treating the particles with a particle cleaning agent. Preferably, said agent comprises at least one surfactant. Preferably said agent comprises an aqueous medium. Typically, the polymeric particles comprise particles of nylon or polyester. The invention also provides a method for cleaning a soiled substrate, the method comprising the steps of: (a) treating polymeric particles with a particle cleaning agent; and (b) treating a moistened substrate with a formulation comprising a multiplicity of said treated polymeric particles. Most preferably, the substrate comprises a textile fibre or fabric. The results obtained are very much in line with those observed when carrying out conventional aqueous cleaning processes and the method provides the significant advantages that the useable lifetime of the polymeric particles is maximised and the economic and environmental burden generated by the polymeric particle cleaning process is minimised.

### FIELD OF THE INVENTION

The present invention relates to the aqueous cleaning of soiled substrates, specifically textile fibres and fabrics, using a cleaning system comprising re-useable polymeric particles. More specifically, the invention is concerned with a system wherein said polymeric particles themselves are intermittently cleaned, in order to extend their useable lifetime.

### BACKGROUND TO THE INVENTION

Aqueous cleaning processes are a mainstay of both domestic and industrial textile fabric washing. On the assumption that the desired level of cleaning is achieved, the efficacy of such processes is usually characterised by their levels of consumption of energy, water and detergent. In general, the lower the requirements with regard to these three components, the more efficient the washing process is deemed. The downstream effect of reduced water and detergent consumption is also significant, as this minimises the need for disposal of aqueous effluent, which is both extremely costly and detrimental to the environment.

Such washing processes, whether in domestic washing machines or their industrial equivalents (usually referred to as washer extractors), involve aqueous submersion of fabrics followed by soil removal, aqueous soil suspension, and water rinsing. In general, the higher the level of energy (or temperature), water and detergent which is used, the better the cleaning. The key issue, however, concerns water consumption, as this sets the energy requirements (in order to heat the wash water), and the detergent dosage (to achieve the desired detergent concentration). In addition, the water usage level defines the mechanical action of the process on the fabric, which is another important performance parameter; this is the agitation of the cloth surface during washing, which plays a key role in releasing embedded soil. In aqueous processes, such mechanical action is provided by the water usage level, in combination with the drum design, for any particular washing machine. In general terms, it is found that the higher the water level in the drum, the better the mechanical action. Hence, there is a dichotomy created by the desire to improve overall process efficiency (i.e. the reduction of energy, water and detergent consumption), and the need for efficient mechanical action in the wash. For domestic washing in particular there are defined wash performance standards specifically designed to discourage the use of such higher levels in practice, in addition to the obvious cost penalties which are associated with such usage.

Current efficient domestic washing machines have made significant strides towards minimising their consumptions of energy, water and detergent. EU Directive 92/75/CEE sets a standard which defines washing machine energy consumption in kWh/cycle (cotton setting at 60° C.), such that an efficient domestic washing machine will typically consume <0.19 kWh/kg of washload in order to obtain an ‘A’ rating. If water consumption is also considered, then ‘A’ rated machines use <9.7 litres/kg of washload.

Detergent dosage is then driven by manufacturer recommendations but, again, in the domestic market, for a concentrated liquid formulation, a quantity of 35 ml (or 37 g) for a 4-6 kg washload in soft and medium hardness water, increasing to 52 ml (or 55 g) for a 6-8 kg washload (or in hard water or for very dirty items) is typical (see, for example, Unilever pack dosage instructions for Persil® Small & Mighty). Hence, for a 4-6 kg washload in soft/medium water hardness, this equates to a detergent dosage of 7.4-9.2 g/kg whilst, for a 6-8 kg washload (or in hard water or for very dirty items), the range is 6.9-9.2 g/kg.

Energy, water and detergent consumptions in the industrial washing process (washer-extractors) are considerably different, however, and usages of all three resources are less constrained, since these are the principal factors in reducing cycle time—which is, of course, more of a consideration than in the case of domestic use. For a typical industrial washer extractor (25 kg washload rated and above), energy consumption is 0.30-1.0 kWh/kg, water is at 20-30 litres/kg, and detergent is much more heavily dosed than for domestic washing. The exact level of detergent used will depend on the amount of soiling, but a range of 20-100 g/kg is representative.

Thus, it can be taken from the above discussion that it is the performance levels in the domestic sector which set the highest standard for an efficient fabric washing process, and that these are: an energy consumption of <0.19 kWh/kg, a water usage of <9.7 litres/kg, and a detergent dosage of approximately 8.0 g/kg. However, as previously observed, it is becoming increasingly difficult to reduce the water (and, hence, energy and detergent) levels in a purely aqueous process, due to the minimum requirement to wet the fabric thoroughly, the need to provide sufficient excess water to suspend the soil removed in an aqueous liquor and, finally, the necessity to rinse the fabric.

Heating of the wash water is then the principal use of energy, and a minimum level of detergent becomes necessary in order for an effective concentration to be reached at the operating wash temperature. Means to improve mechanical action without increasing the water level used would, therefore, make any aqueous wash process significantly more efficient (i.e. yield further reductions in energy, water and detergent consumption). It should be noted that mechanical action itself has a direct effect on the detergent level, since the greater the level of soil removal which is achieved through physical force, the less that is required of the detergent chemistry. However, increasing the mechanical action in a purely aqueous washing process has certain associated drawbacks. Fabric creasing readily occurs in such processes, and this acts to concentrate the stresses from mechanical action at each crease, resulting in localised fabric damage. Prevention of such fabric damage (i.e. fabric care) is of primary concern to the domestic consumer and the industrial user.

In the light of these challenges which are associated with aqueous washing processes, the present inventors have previously devised a new approach to the problem, which allows the deficiencies demonstrated by the methods of the prior art to be overcome. The method which is provided eliminates the requirement for the use of large volumes of water, but is still capable of providing an efficient means of cleaning and stain removal, whilst also yielding economic and environmental benefits.

Thus, in WO-A-2007/128962, there is disclosed a method and formulation for cleaning a soiled substrate, the method comprising the treatment of the moistened substrate with a formulation comprising a multiplicity of polymeric particles, wherein the formulation is free of organic solvents. Preferably, the substrate is wetted so as to achieve a substrate to water ratio of between 1:0.1 to 1:5 w/w, and optionally, the formulation additionally comprises at least one cleaning material, which typically comprises a surfactant, which most preferably has detergent properties. In preferred embodiments, the substrate comprises a textile fibre and the polymeric particles comprise, for example, particles of polyamides, polyesters, polyalkenes, polyurethanes or their copolymers but, most preferably, are in the form of nylon beads.

The use of this polymeric cleaning method, however, presents a requirement for the cleaning particles to be efficiently separated from the cleaned substrate at the conclusion of the cleaning operation, and this issue is addressed in WO-A-2010/094959, which provides a novel design of cleaning apparatus requiring the use of two internal drums capable of independent rotation, and which finds application in both industrial and domestic cleaning processes.

In co-pending WO-A-2011/064581, there is provided a further apparatus which facilitates efficient separation of polymeric cleaning particles from the cleaned substrate at the conclusion of the cleaning operation, and which comprises a perforated drum and a removable outer drum skin which is adapted to prevent the ingress or egress of fluids and solid particulate matter from the interior of the drum, the cleaning method requiring attachment of the outer skin to the drum during a wash cycle, after which the skin is removed prior to operating a separation cycle to remove the cleaning particles, following which the cleaned substrate is removed from the drum.

In a further development of the apparatus of WO-A-2011/064581, there is disclosed in co-pending WO-A-2011/098815 a process and apparatus which provides for continuous circulation of the polymeric cleaning particles during the cleaning process, and thereby dispenses with the requirement for the provision of an outer skin.

Further benefits in terms of reduced power and consumable requirements for the cleaning method originally proposed in WO-A-2007/128962 have been disclosed in co-pending GB Patent Application No. 1018318.4, where the technology has been refined to achieve at least equivalent cleaning performance whilst employing significantly reduced levels of detergents and much lower process temperatures.

The apparatus and methods disclosed in the foregoing prior art documents have been highly successful in providing an efficient means of polymeric cleaning and stain removal which also yields significant economic and environmental benefits. As reported in WO-A-2007/128962, re-use of the polymeric particles is possible but it is possible that cleaning performance can fall if the same particles are used for more than three wash cycles. Co-pending application WO-A-2011/098815 states that the particle re-use aspect of the cleaning processes disclosed therein is preferred, however, and it is obviously beneficial from both economic and environmental considerations. WO-A-2011/098815 goes further, therefore, by describing means to extend the useable lifetime of said particles by subjecting them to a cleaning operation in a second chamber of the washing apparatus. This can be achieved by sluicing said chamber with clean water in the presence or absence of a cleaning agent, which may be selected from at least one of surfactants, enzymes and bleaches. Alternatively, cleaning of the polymeric particles may be achieved as a separate stage in the rotatably mounted cylindrical cage of the disclosed apparatus—i.e. by running the washing process without any washload in the machine. It is also mentioned that, after cleaning, the polymeric particles are recovered such that they are available for use in subsequent washes.

Hence, in attempting to further develop the method of the cleaning processes from WO-A-2007/128962 and co-pending WO-A-2011/098815, the present inventors are now seeking to provide a specific process and formulation for cleaning the polymeric particles which, in combination, maximise the number of fabric washes that can be successfully performed by the machine before repeat cleaning of the polymeric particles is required. In addressing this issue, they have de facto also maximised the useable lifetime of the polymeric particles, and minimised the economic and environmental burden generated by the polymeric particle cleaning process.

### STATEMENTS OF INVENTION

Thus, according to a first aspect of the present invention, there is provided a method for the treatment of polymeric particles recovered after use in cleaning processes for soiled substrates, said method comprising treating said particles with a particle cleaning agent.

Typically, the processes for cleaning soiled substrates comprise the treatment of the moistened substrate with a formulation comprising a multiplicity of said polymeric particles.

The substrate cleaned by said cleaning processes may comprise any of a wide range of substrates, including, for example, plastics materials, leather, paper, cardboard, metal, glass or wood. In practice, however, said substrate most preferably comprises a textile fibre or fabric, which may comprise either a natural material, such as cotton, or a synthetic textile material, for example nylon 6,6 or a polyester.

Polymeric particles are typically treated according to the method of the invention following use in said cleaning processes for soiled substrates, and may subsequently be re-used in further such cleaning processes with little or no reduction in their cleaning efficiency. Particles may be cleaned and re-used in this manner on multiple occasions, and optimum performance has been achieved with particles which have been cleaned according to the method of the invention and re-used for the cleaning of soiled substrates in up to 500 substrate cleaning cycles.

Thus, a second aspect of the present invention also envisages a method for cleaning a soiled substrate, said method comprising the steps of:
(a) treating polymeric particles recovered after use in cleaning processes for soiled substrates, said treatment comprising treating said particles with a particle cleaning agent; and
(b) treating a moistened substrate with a formulation comprising a multiplicity of said treated polymeric particles.

The treatment process for said polymeric particles involves treating the particles with a particle cleaning agent which comprises at least one surfactant. Optimally said particle cleaning agent is an aqueous liquor. Optimally, said particle cleaning agent also comprises at least one additional component selected from enzymes, oxidising agents/bleaches and biocides.

Optionally said particle cleaning agent may additionally comprise one or more additional components selected from stabilisers, wetting agents and solvents, with the balance of the formulation being made up with water. Said additional components typically provide improved chemical stability and dissolution properties.

Preferred surfactants comprise surfactants having detergent properties, and said particle cleaning agent preferably comprises a detergent formulation. Said surfactants may comprise anionic, non-ionic, cationic, ampholytic, zwitterionic and/or semi-polar non-ionic surfactants. Preferred enzymes include, but are not limited to, amylase, protease, lipase and mannanase. Oxygen or chlorine derived bleaches may be combined with said surfactants, in addition to suitable liquid biocides to inhibit mould and bacterial growth at the particle surface.

Suitable examples of apparatus for the execution of the methods of the invention are disclosed in WO-A-2010/094959, WO-A-2011/064581 and WO-A-2011/098815. The claimed method for the cleaning of soiled substrates additionally provides for separation and recovery of the polymeric particles, which are then re-used in subsequent washes.

Thus, the polymeric particle cleaning operation can conveniently be carried out in a second chamber of a washing apparatus as described in WO-A-2011/098815. This can be achieved by sluicing said chamber with clean water in the presence or absence of said particle cleaning agent. Preferably, cleaning of the polymeric particles may be achieved as a separate stage in the rotatably mounted cylindrical cage of this apparatus—i.e. by running the washing process without any washload in the machine. In this embodiment, the temperature of the water used to aid circulation of the polymeric particles in the machine, is generally heated to a temperature from 5° to 95° C., more preferably from 30° to 75° C., and most preferably from 35° to 65° C. Said treatment is typically carried out for a duration of from 5 to 120 minutes, more preferably from 10 to 90 minutes, and most preferably from 15 to 60 minutes, at the desired temperature. The recited times and temperatures are also appropriate to other embodiments of the invention.

Said polymeric particles may comprise any of a wide range of different polymers. Specifically, there may be mentioned polyalkenes such as polyethylene and polypropylene, polyesters and polyurethanes. Preferably, however, said polymeric particles comprise polyester or polyamide particles, most particularly particles of polyethylene terephthalate, polybutylene terephthalate, nylon 6, and nylon 6,6, most preferably in the form of beads. Said polyesters and polyamides are found to be particularly effective for aqueous stain/soil removal, whilst polyalkenes are especially useful for the removal of oil-based stains. Optionally, copolymers of the above polymeric materials may be employed for the purposes of the invention.

Specifically, the properties of the polymeric materials may be tailored to particular requirements by the inclusion of monomeric units which confer desired properties on the copolymer. Thus, the polymers may be adapted to attract particular staining materials by comprising co-monomers which, inter alia, are ionically charged, or include polar moieties or unsaturated organic groups. Examples of such groups may include, for example, acid or amino groups, or salts thereof, or pendant alkenyl groups.

Furthermore, the polymeric particles may comprise either foamed or unfoamed polymeric materials. Additionally, the polymeric particles may comprise polymers which are either linear or crosslinked, and said particles may be solid or hollow.

As previously stated, various polyester and/or polyamide homo- or co-polymers may be used for the polymeric particles, including polyethylene terephthalate, polybutylene terephthalate, nylon 6 and nylon 6,6. Preferably, the nylon comprises nylon 6,6 homopolymer having a molecular weight in the region of from 5000 to 30000 Daltons, preferably from 10000 to 20000 Daltons, most preferably from 15000 to 16000 Daltons. The polyester will typically have a molecular weight corresponding to an intrinsic viscosity measurement in the range of from 0.3-1.5 dl/g as measured by a solution technique such as ASTM D-4603.

The polymeric particles are of such a shape and size as to allow for good flowability and intimate contact with the soiled substrate, which typically comprises a textile fibre or fabric. A variety of shapes of particles can be used, such as cylindrical, spherical or cuboid; appropriate cross-sectional shapes can be employed including, for example, annular ring, dog-bone and circular. In preferred embodiments of the invention, said particles are in the form of beads and, most preferably, comprise cylindrical or spherical beads.

The particles may have smooth or irregular surface structures and can be of solid or hollow construction. Particles are of such a size as to have an average mass of 1-50 mg, preferably from 10-30 mg, more preferably from 12-25 mg.

In the case of cylindrical beads, the preferred particle diameter is in the region of from 1.0 to 6.0 mm, more preferably from 1.5 to 4.0 mm, most preferably from 2.0 to 3.0 mm, and the length of the beads is preferably in the range from 1.0 to 5.0 mm, more preferably from 1.5 to 3.5 mm, and is most preferably in the region of 2.0 to 3.0 mm.

Typically, for spherical beads, the preferred diameter of the sphere is in the region of from 1.0 to 6.0 mm, more preferably from 2.0 to 4.5 mm, most preferably from 2.5 to 3.5 mm.

Once cleaned according to the method of the invention, the polymeric particles can be used in substrate washing cycles within apparatus such as that described in WO-A-2011/098815. Repeat substrate washing cycles can then be carried out with numerous washloads of soiled substrates, typically soiled textile fibres or fabrics, until either the cleaning performance, or the colour of the polymeric particles themselves, becomes unacceptable to the operator. Both factors are dependent on the level of soiling encountered in the washloads concerned and, hence, it is not possible to precisely specify an exact number of such washes before a polymeric particle cleaning cycle should be performed. Experience, however, dictates that for a lightly soiled garment washload (e.g. household laundry), it will be typically be >20 fabric wash cycles before particle cleaning becomes necessary whereas, with very heavily soiled industrial laundry washloads (e.g. car mechanics' overalls), this will typically drop to once in every 6 such wash cycles. In addition, if there is a switch from a very heavily soiled washload, such as that specified, to a subsequent washload which is particularly colour sensitive (e.g. white table linen), it will be necessary to perform a particle cleaning cycle ahead of that switch, in order to ensure no carry over of soil between the two washes. Hence, it can be seen that polymeric particle cleaning can be an important contributor to fabric washing processes as carried out in the apparatus of WO-A-2011/098815 and co-pending applications, as described above.

When carrying out the substrate washing processes, the ratio of polymeric particles to substrate is generally in the range of from 0.1:1 to 10:1 w/w, preferably in the region of from 0.5:1 to 5:1 w/w, with particularly favourable results being achieved with a ratio of between 1:1 and 3:1 w/w, and especially at around 2:1 w/w. Thus, for example, for the cleaning of 5 g of substrate, typically textile fabric, 10 g of polymeric particles, optionally coated with surfactant, would be employed in one embodiment of the invention. The ratio of polymeric particles to substrate is maintained at a substantially constant level throughout the wash cycle.

The substrate cleaning method according to the invention may be applied to a wide variety of substrates, as previously stated. More specifically, it is applicable across the range of natural and synthetic textile fibres and fabrics, but it finds particular application in respect of nylon 6,6, polyester and cotton fabrics.

Prior to treatment according to the method of the invention, the substrate is moistened by wetting with water, to provide additional lubrication to the cleaning system and thereby improve the transport properties within the system. Thus, more efficient transfer of the at least one cleaning material to the substrate is facilitated, and removal of soiling and stains from the substrate occurs more readily. Most conveniently, the substrate may be wetted simply by contact with mains or tap water. Preferably, the wetting treatment is carried out so as to achieve a substrate to water ratio of between 1:0.1 to 1:5 w/w; more preferably, the ratio is between 1:0.2 and 1:2, with particularly favourable results having been achieved at ratios such as 1:0.2, 1:1, 1:1.2 and 1:2. However, in some circumstances, successful results can be achieved with substrate to water ratios of up to 1:50, although such ratios are not preferred in view of the significant amounts of effluent which are generated.

As a consequence of employing the substrate cleaning method of the present invention, excellent cleaning performance may be achieved whilst using significantly reduced levels of detergents and much lower process temperatures. Thus, fabric and fibre cleaning operations according to the invention, whilst possible at temperatures of up to 95° C., are typically carried out at temperatures not exceeding 65° C., and optimum performance is generally achieved at 5-35° C., generally for a duration of between 5 and 45 minutes, and usually in a substantially sealed system.

It is throughout the repeated substrate washing cycles, carried out as described above, that the polymeric particles are treated by the intermittent cleaning process according to the present invention, in order to extend their useable lifetime.

According to a further aspect of the present invention, there is provided a formulation for cleaning a soiled substrate, said formulation comprising a multiplicity of polymeric particles, wherein said particles have been treated with a particle cleaning agent according to the method of the first aspect of the invention.

Said substrate may comprise any of a wide range of substrates, including, for example, plastics materials, leather, paper, cardboard, metal, glass or wood. In practice, however, said substrate most preferably comprises a textile fibre or fabric, which may comprise either a natural material, such as cotton, or a synthetic textile material, for example nylon 6,6 or a polyester.

In one embodiment, said formulation may essentially consist only of said multiplicity of polymeric particles treated with said particle cleaning agent but, optionally, in other embodiments said formulation further comprises at least one additional fabric cleaning agent. Preferably, the at least one additional fabric cleaning agent comprises at least one surfactant. Preferred surfactants comprise surfactants having detergent properties and said additional fabric cleaning agents preferably comprise detergent formulations. Said surfactants may comprise anionic, non-ionic, cationic, ampholytic, zwitterionic, and/or semi-polar non-ionic surfactants. Optionally, said at least one additional fabric cleaning agent also comprises at least one enzyme and/or bleach.

Said formulation is preferably used in accordance with the method of the second aspect of the invention, and is as defined in respect thereof. Additional additives may be incorporated in said formulation, as appropriate; said additives may include, for example, anti-redeposition additives, optical brighteners, perfumes, softeners and starch which can enhance the appearance and other properties of the cleaned substrate.

The formulation and the methods of the present invention may be used for either small or large scale processes of both the batchwise and continuous variety and, therefore, find application in both domestic and industrial cleaning processes. Excellent performance can also result from the use of fluidised beds, and this is particularly the case when the method of the second aspect of the invention is used for carrying out wet cleaning processes.

### BRIEF DESCRIPTION OF THE DRAWINGS

Embodiments of the invention are further described hereinafter with reference to the accompanying drawings, in which:

FIGS. 1(a) and (b) show an apparatus suitable for use in the performance of the method of the invention.

### DETAILED DESCRIPTION OF THE INVENTION

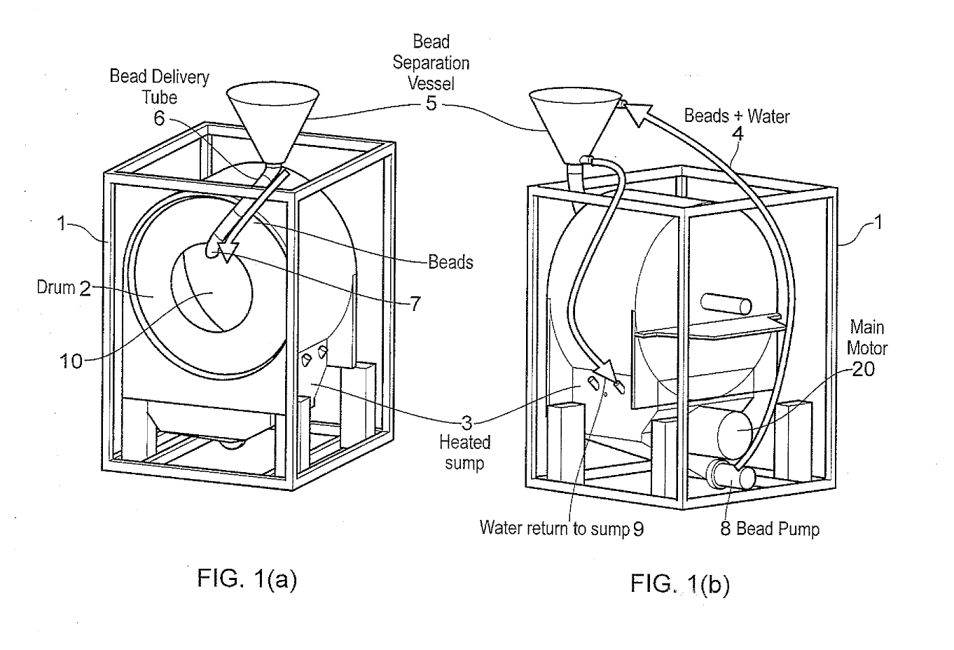

A typical operation of the polymeric particle cleaning cycle according to the method of the present invention can be carried out in cleaning apparatus such as that described in WO-A-2011/098815. Said apparatus is illustrated in FIGS. 1(a) and (b), wherein there is shown an apparatus comprising housing means (1) having a first upper chamber having mounted therein a rotatably mounted cylindrical cage in the form of drum (2) (perforations not shown) and a second lower chamber comprising sump (3) located beneath said cylindrical cage. The apparatus additionally comprises, as first recirculation means, bead and water riser pipe (4) which feeds into separating means comprising a bead separation vessel (5), including filter material, typically in the form of a wire mesh, and a bead release gate valve which feeds into feeder means comprising bead delivery tube (6) mounted in cage entry (7). The first recirculation means is driven by pumping means comprising bead pump (8). Additional recirculation means comprises return water pipe (9), which allows water to return from the bead separation vessel (5) to the sump (3) under the influence of gravity. The apparatus also comprises access means shown as loading door (10), though which material for cleaning may be loaded into drum (2). The main motor (20) of the apparatus, responsible for driving the drum (2), is also depicted.

At the commencement of the polymer particle cleaning cycle the apparatus contains no washload, and the polymeric particles to be cleaned are held with an amount of water (usually 1:1 w/w) in said second chamber (3) of the apparatus. This water is typically some or all of the residual rinse water used in the previous substrate washing cycle. The polymeric particles and water are then pumped by the pumping means (8) to the separating means (5), from which the polymeric particles are transferred to the rotatably mounted cylindrical cage (2). The water passing through said separating means (5) is returned to the second chamber (3). Pumping continues until the polymeric particles are essentially removed from the second chamber (3). At this stage of the process said cage (2) is held stationary, in order to retain the polymeric particles. The perforations in the wall of the rotatably mounted cylindrical cage (2) will allow some polymeric particles to fall back into the second chamber (3), but the number doing so is very small, as the ratio of the perforation diameter to that of the particle is only slightly greater than 1 (typically 1.2-3.5), and the action of pumping the polymeric particles into the cage (2) causes these to quickly accumulate, so as to prevent further flow of particles through said perforations. Pumping continues until transfer of the polymeric particles into the cage (2) is complete.

Optionally the polymeric particle cleaning agent can be introduced into said second chamber (3) and mixed with the water therein at this stage in the procedure. Alternatively, the particle cleaning agent can be diluted in fresh water and introduced directly onto the particles in the cage (2), by using spray means through the access means (10) at the front of the cage (2), in order to facilitate more uniform coverage of the particles. The particle cleaning agent can also be introduced via the separating means (5), although this is a less preferred mode of operation.

The pumping means (8) then acts to circulate the polymeric particles, water and particle cleaning agent into the now rotating cage (2), such that the fluids and a quantity of the particles are continually exiting through the perforations in the cage wall. In all such embodiments of the invention, the process of circulating the particles, water and particle cleaning agent from the second chamber (3), via pumping means (8) and separating means (5) to the rotating cage (2) and back to the second chamber (3), then continues throughout the particle cleaning cycle. Optionally, the water used may be heated, so as to further improve cleaning performance. In this embodiment of the invention the water circulated with the polymeric particles in the machine is preferably heated to a temperature of from 5° to 95° C., more preferably from 30° to 75° C., and most preferably from 35° to 65° C. Said treatment is carried out for a duration of from 5 to 120 minutes, more preferably from 10 to 90 minutes, and most preferably from 15 to 60 minutes, at the desired temperature.

Following this part of the process, the particles are again pumped into the cage (2) via the separating means (5), said cage (2) once again being held stationary. The water returned to the second chamber (3) from the separating means (5) during this transfer now contains the soil liberated from the particles, and so it is drained away, to be replaced with fresh water. Optionally the second chamber (3) may be sluiced with fresh water a number of times, or additionally cleaned with water containing a cleaning agent, in order to remove any remaining contaminants. The water, with or without cleaning agent, may optionally be heated. With the second chamber (3) now full of fresh water, the rotatably mounted cage (2) is once more caused to rotate, and the polymeric particles are allowed to fall back into the second chamber (3).

At the conclusion of the polymeric particle cleaning process, the apparatus is then ready to begin again the process of substrate cleaning, typically textile fibre and fabric washing, as described above and, for example, in WO-A-2011/098815. The degree of soiling of the fabric washed will dictate the frequency with which the particle cleaning cycle is required to be re-run. Obviously, more heavily soiled fabrics will necessitate more frequent particle cleaning and vice versa. It is therefore not possible to precisely specify an exact number of fabric washes before a particle cleaning cycle is required to be performed. Experience, however, dictates that, for a lightly soiled garment washload (e.g. household laundry), it will be typically be >20 fabric wash cycles before particle cleaning becomes necessary whereas, with very heavily soiled industrial laundry washloads (e.g. car mechanics' overalls), this will typically drop to once in every 6 such wash cycles. In addition, if there is a switch from a very heavily soiled washload, such as that described, to a subsequent washload which is particularly colour sensitive (e.g. white table linen), it will be necessary to perform a particle cleaning cycle ahead of that switch, in order to ensure no carry over of soil between those washes.

Thus, by careful control of the composition of the particle cleaning agent, and the temperature and time of the particle cleaning cycle, the number of fabric washes that can be successfully performed by the machine before repeat cleaning of the polymeric particles is required can be maximised. In so doing, the useable lifetime of the polymeric particles is also maximised, and the economic and environmental burden generated by the polymeric particle cleaning process is minimised.

In order to achieve the desired benefits associated with the invention, the particle cleaning agent is optimally specifically formulated to include a combination of surfactants, enzymes, oxidising agents/bleaches and biocides, together with any necessary stabilisers, wetting agents and solvents. Preferred surfactants comprise surfactants having detergent properties, and said particle cleaning agent preferably comprises a detergent formulation. Said surfactants may comprise anionic, non-ionic, cationic, ampholytic, zwitterionic and/or semi-polar non-ionic surfactants. Preferred enzymes include but are not limited to amylase, protease, lipase and mannanase. Oxygen or chlorine derived bleaches may be combined with said surfactants, in addition to suitable liquid biocides to inhibit mould and bacterial growth at the particle surface.

Additional components may be added to the particle cleaning agent in order to provide chemical stability and dissolution, with the balance of the formulation being made up with water. Said additional components may optionally include builders, chelating agents, dispersants, enzyme stabilizers, catalytic materials, bleach activators, polymeric dispersing agents, anti-redeposition additives, perfumes, optical brighteners, clay soil removal agents, suds suppressors, dyes, structure elasticizing agents, carriers, hydrotropes, processing aids and/or pigments.

As stated, examples of suitable surfactants may be selected from non-ionic and/or anionic and/or cationic surfactants and/or ampholytic and/or zwitterionic and/or semi-polar nonionic surfactants. The surfactant may be present at a level of from about 0.1% to about 99.9% by weight of the particle cleaning agent composition, but is usually present from about 1% to about 80%, more typically from about 5% to about 35%, or from about 5% to 30% by weight of said particle cleaning agent composition.

The particle cleaning composition optimally also includes one or more detergent enzymes which provide cleaning performance benefits. Examples of suitable enzymes include, but are not limited to, hemicellulases, peroxidases, proteases, other cellulases, other xylanases, lipases, phospholipases, esterases, cutinases, pectinases, keratanases, reductases, oxidases, phenoloxidases, lipoxygenases, ligninases, pullulanases, tannases, pentosanases, malanases, [beta]-glucanases, arabinosidases, hyaluronidase, chondroitinase, laccase, and amylases, or mixtures thereof. A typical combination may comprise a mixture of enzymes such as protease, lipase, cutinase and/or cellulase in conjunction with amylase.

Optionally, enzyme stabilisers may also be included amongst the cleaning components. In this regard, enzymes for use in detergents may be stabilised by various techniques, for example by the incorporation of water-soluble sources of calcium and/or magnesium ions in the compositions.

The particle cleaning composition typically also includes one or more oxidising agents/bleach compounds and associated activators. Examples of such bleach compounds include, but are not limited to, peroxygen compounds, including hydrogen peroxide, inorganic peroxy salts, such as perborate, percarbonate, perphosphate, persilicate, and monopersulphate salts (e.g. sodium perborate tetrahydrate and sodium percarbonate), and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. Bleach activators include, but are not limited to, carboxylic acid esters such as tetraacetylethylenediamine and sodium nonanoyloxybenzene sulfonate. Chlorine based bleaches (e.g. sodium hypochlorite) may also be used.

Suitable builders may be included in the formulations and these include, but are not limited to, the alkali metal, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

The particle cleaning agent formulation may also optionally contain one or more copper, iron and/or manganese chelating agents.

Optionally, the said formulation can also contain dispersants. Suitable water-soluble organic materials are the homo- or co-polymeric acids or their salts, in which the polycarboxylic acid may comprise at least two carboxyl radicals separated from each other by not more than two carbon atoms.

Suitable anti-redeposition additives are physico-chemical in their action and include, for example, materials such as polyethylene glycol, polyacrylates and carboxy methyl cellulose.

Optionally, the particle cleaning agent may also contain perfumes. Suitable perfumes are generally multi-component organic chemical formulations, a typical example of which is Amour Japonais supplied by Symrise® AG.

Appropriate optical brighteners for use in said particle cleaning agent formulations fall into several organic chemical classes, of which the most popular are stilbene derivatives, whilst other suitable classes include benzoxazoles, benzimidazoles, 1,3-diphenyl-2-pyrazolines, coumarins, 1,3,5-triazin-2-yls and naphthalimides. Examples of such compounds include, but are not limited to, 4,4′-bis[[6-anilino-4(methylamino)-1,3,5-triazin-2-yl]amino]stilbene-2,2′-disulfonic acid, 4,4′-bis[[6-anilino-4-[(2-hydroxyethyl)methylamino]-1,3,5-triazin-2-yl]amino]stilbene-2,2′-disulphonic acid, disodium salt, 4,4′-Bis[[2-anilino-4-[bis(2-hydroxyethyl)amino]-1,3,5-triazin-6-yl]amino]stilbene-2,2′-disulfonic acid, disodium salt, 4,4′-bis[(4,6-dianilino-1,3,5-triazin-2-yl)amino]stilbene-2,2′-disulphonic acid, disodium salt, 7-diethylamino-4-methylcoumarin, 4,4′-Bis[(2-anilino-4-morpholino-1,3,5-triazin-6-yl)amino]-2,2′-stilbenedisulfonic acid, disodium salt, and 2,5-bis(benzoxazol-2-yl)thiophene.

The methods of the present invention may be used in the context of either small or large scale batchwise or continuous processes and find application in both domestic and industrial cleaning processes.

The invention will now be further illustrated, though without in any way limiting the scope thereof, by reference to the following examples.

### EXAMPLES

### Example 1

Two fabric cleaning cycles were carried out using an apparatus as described in WO-A-2011/098815. This apparatus was based on a 50 kg Sea Lion industrial washer-extractor, modified to run with polymeric particles and, hence, it additionally comprised a second chamber, pumping means, separating means, and rotatably mounted cylindrical cage, as described in WO-A-2011/098815. The polymeric particles were polyethylene terephthalate (polyester) grade 1101 E, as supplied by INVISTA, Gersthofen, Germany. The mass of particles in the apparatus was 50 kg. Both fabric washing cycles cleaned very highly soiled car mechanics' overalls—20.8 and 20.0 kg washloads respectively, as supplied by Watford Launderers, London, UK. The cycles were both run at wash temperatures of 65° C., with a 35 minute wash, followed by three rinses each of 10 minutes, whilst using the following fabric cleaning agents, added sequentially throughout the fabric cleaning cycle as shown:
a) 465.0 g Selox Mild—Christeyns, Bradford, UK (surfactant, added at the start of the wash);
b) 8.4 g Antifoam RD Emulsion—DOW Corning, Barry, UK (antifoaming agent, added at the start of the wash);
c) 223.2 g Mulan 200S—Christeyns (surfactant booster, added at the start of the wash);
d) 231.9 g Metajet Ultra—Christeyns (sodium hydroxide solution, 15-30% aqueous, added after 10 minutes of the wash);
e) 16.8 g Antifoam RD Emulsion—DOW Corning (added after 10 minutes of the wash);
f) 258.4 g Sodium Hypochlorite—Christeyns (sodium hypochlorite solution, 14-15% aqueous, added after 20 minutes of the wash);
g) 100.0 g of Jetstream Jetsour—Christeyns (sodium bisulphite solution 15-30% aqueous, added during the first rinse); and
h) 5.0 g Leucophor BMB Liquid—Vision Chemicals, Leeds, UK—(optical brightening agent, 50% aqueous, added during the final rinse).

The water consumption of these fabric cleaning cycles was 176 litres each (8.5 and 8.8 litres/kg of washload respectively), and the power consumption was 13.3 kWh each (0.64 and 0.67 kWh/kg respectively). There were very few polymeric particles left in the washload at the end of the process, and the cleaning and deodourising of the washload in general were excellent. The fabric cleaning agent dosages, the water consumption and the power usage were all significantly less than those observed with the corresponding conventional aqueous processes.

Each of these fabric cleaning cycles liberated approximately 1 kg of soil into the washing apparatus (2 kg in total), thereby necessitating a polymeric particle cleaning cycle. This was carried out according to the procedure previously described.

At the commencement of the polymeric particle cleaning cycle the apparatus contained no washload, and the polymeric particles to be cleaned were held with an amount of water (1:1 w/w) in the second chamber of the apparatus. This water was 67% of the residual rinse water used in the previous fabric washing cycles. The polymeric particles and water were then pumped by pumping means to the separating means, from where the polymeric particles were transferred to the rotatably mounted cylindrical cage of the apparatus. The water passing through the separating means was returned to the second chamber. Pumping continued until the polymeric particles were essentially removed from the second chamber.

At that stage of the process, the cage was held in a stationary position in order to retain the polymeric particles. The perforations in the wall of the rotatably mounted cylindrical cage allowed some polymeric particles to fall back into the second chamber, but the number doing so was very small, as the ratio of the perforation diameter to that of the particles was only slightly greater than 1 (5 mm perforations and 2.1 mm polymeric particles, so the ratio was 2.4), and the action of pumping the polymeric particles into the cage ensured that these quickly accumulated, thereby preventing further flow of particles through the perforations. Pumping continued until transfer of the polymeric particles into the cage was complete.

The polymeric particle cleaning agent was diluted in fresh water (100.0 g of cleaning agent in ˜30 litres of water in the dosage means of the machine), and introduced directly onto the particles in the cage, by using spray means through the access means at the front of the cage, so as to provide more uniform coverage of the particles. The particle cleaning agent formulation was as shown in Table 1.

TABLE 1
Particle Cleaning Agent Formulation

| | Typical Concentration | |
|---|---|---|
| Material (Supplier) | (as supplied w/w %) | Function |
| 25% Sodium | 2.0 | Anionic surfactant |
| Dodecabenzene Sulphonate | | |
| (Biosoft SDBS25) | | |
| (Stepan Company) | | |
| Neodol 25-7 (Shell) | 0.5 | Non-ionic surfactant |
| Surfadone LP100 (Ashland) | 1.0 | Solvent and |
| | | wetting agent |
| 30% Tegotens DO (Evonik | 1.6 | Cationic surfactant |
| Degussa) | | and biocide |
| Ethyleneglycol monobutyl | 0.6 | Solvent |
| ether (Brenntag) | | |
| Mirapol A300 (Surfachem) | 0.2 | Chelant and |
| | | peroxide stabiliser |
| 6% Hydrogen Peroxide | 94.1 | Oxidiser and biocide |
| (Brenntag) | | |

The pumping means was then used to circulate the polymeric particles, water and particle cleaning agent into the now rotating cage, such that the fluids and a quantity of the particles were continually exiting through the perforations in the cage wall. The process of circulating the particles, water and particle cleaning agent from the second chamber, via pumping means and separating means, to the rotating cage, and back to the second chamber, then continued throughout the particle cleaning cycle. The water used was heated to 45° C. in order to further improve cleaning performance, and the treatment was carried out for a duration of 15 minutes.

Following this part of the process, the particles were again pumped into the cage via the separating means, the cage once again being held stationary. The water which returned to the second chamber from the separating means during this transfer contained the soil liberated from the particles, and so it was drained away and replaced with fresh water. The rotatably mounted cage was once more caused to rotate, and the polymeric particles were allowed to fall back into the second chamber.

At the conclusion of the polymeric particle cleaning process, the apparatus was ready to begin again the process of fabric washing as described above. The next such cycle cleaned 20.0 kg of white table linen, again as supplied by Watford Launderers, London, UK. This cycle was carried out at ambient temperature (˜20° C.), with a 35 minute wash, followed by three rinses each of 10 minutes, using the following fabric cleaning agents, added sequentially throughout the fabric cleaning cycle as specified:
a) 930.0 g Selox Mild—Christeyns, Bradford, UK (surfactant, added at the start of the wash);
b) 16.8 g Antifoam RD Emulsion—DOW Corning, Barry, UK (antifoaming agent, added at the start of the wash);
c) 49.6 g Mulan 200S—Christeyns (surfactant booster, added at the start of the wash);
d) 347.9 g Metajet Ultra—Christeyns (sodium hydroxide solution, 15-30% aqueous, added after 10 minutes of the wash);
e) 8.4 g Antifoam RD Emulsion—DOW Corning (added after 10 minutes of the wash);
f) 258.4 g Sodium Hypochlorite—Christeyns (sodium hypochlorite solution, 14-15% aqueous, added after 20 minutes of the wash);
g) 100.0 g of Jetstream Jetsour—Christeyns (sodium bisulphite solution 15-30% aqueous, added during the first rinse); and
h) 5.0 g Leucophor BMB Liquid—Vision Chemicals, Leeds, UK—(optical brightening agent, 50% aqueous, added during the final rinse).

The water consumption for these fabric cleaning cycles was 170 litres (8.5 litres/kg of washload), and the power consumption was 1.6 kWh (0.08 kWh/kg). There were very few polymeric particles left in the washload at the end of the process, and the cleaning of the washload overall was excellent. Once again, the fabric cleaning agent dosages, the water consumption and the power usage were all significantly less than observed with the corresponding conventional aqueous process.

Significantly however, there was no carry over of soil from the preceding two washes of mechanics overalls, thereby proving the efficacy of the polymeric particle cleaning cycle run between the fabric washes.

### Example 2

The efficacy of the particle cleaning formulation of Table 1 was further evaluated. Thus, polymeric particles were pre-soiled by taking 12 kg of virgin 1101E particles, and adding to this the residual liquor from boiling 12 SBL2004 sebum cloths (WFK) in 3 litres of water for 30 minutes, 700 g of tomato ketchup (Heinz), 200 g of instant coffee powder (Morrisons, Value Range), 440 g of curry sauce (Morrisons, Value Range), 1200 g of motor oil (Halfords) and, finally, a further 9 litres of water. This mixture was left at room temperature for three weeks, and stirred for 30 minutes each day over that period.

Industry recognised stain sets (WFK Standard Industry/Commercial Laundry Monitor PCMS-55_{—}05-05×05) were used to record cleaning efficacy. Three of said stain sets were added to 1 kg of dry cotton ballast (Whaleys, Bradford, UK), with 3 kg of pre-soiled polymeric particles (INVISTA 1101E), and 9 litres of water, and this complete washload was then heated to 60° C. and tumbled in a sealed metal drum for a period of two hours. A lifter (metal ridge running axially along the inner surface of the drum) was used to agitate the washload under tumbling (auto reversing every 10 minutes, at ˜40 rpm). The resulting cleaning efficacy was recorded as Run BCP2/1 for each of the stains on the WFK PCMS-55_{—}05-05×05 stain sets, and averaged over the three sets used.

The exact fabric cleaning procedure of Run BCP2/1 was then repeated, with the exception that the 3 kg of pre-soiled polymeric particles were cleaned using the particle cleaning formulation of Table 1. Approximately 500 g of said formulation was diluted with 1 litre of water before being used to clean the particles in a large beaker at 45-50° C. for 30 minutes. The polymeric particles were continually stirred during this cleaning process. After this cleaning procedure, the polymeric particles were filtered and rinsed with 500 ml of clean water. The resulting cleaning efficacy was recorded as Run BCP3/1 for each of the stains on the WFK PCMS-55_{—}05-05×05 stain sets, and averaged over the three sets used.

The exact fabric cleaning procedure of Run BCP2/1 was then repeated, with the exception that virgin 1101 E particles were used. The resulting cleaning efficacy was recorded as Run BCP4/1 for each of the stains on the WFK PCMS-55_{—}05-05×05 stain sets, and averaged over the three sets used.

It should be emphasised that in all three of the above runs (BCP2/1, BCP 3/1 and BCP4/1), no additional fabric cleaning agent was used, i.e. the cleaning recorded is that which was achieved solely due to the action of the polymeric particles.

The level of cleaning was assessed using colour measurement. Reflectance values of the WFK stain monitors were measured using a Datacolor Spectraflash SF600 spectrophotmeter interfaced to a personal computer, employing a 10° standard observer, under illuminant D₆₅, with the UV component included and specular component excluded; a 3 cm viewing aperture was used. The CIE L* colour co-ordinate was taken for each stain on the stain monitors, and these values were then averaged for each stain type, with higher L* values show better cleaning. The results are shown in Table 2.

TABLE 2
Cleaning Results

| | | | | | (BCP 3/1 L* − BCP2/1 L*)/ |
|---|---|---|---|---|---|
| WFK Stain | | BCP2/1 | BCP 3/1 | BCP 4/1 | (BCP 4/1 L* − BCP 2/1 L*) |
| Set Coding | Stain Type | L* | L* | L* | (%) |
| 10C | Pigment/lanolin on | 59.84 | 70.74 | 77.80 | 61 |
| | cotton | | | | |
| 20C | Pigment/lanolin on | 66.13 | 67.72 | 72.58 | 25 |
| | polyester/cotton | | | | |
| 90LI | Red wine on cotton, | 69.05 | 83.41 | 84.76 | 91 |
| | aged (IEC 456) | | | | |
| 10D | Sebum/pigment on | 62.27 | 73.15 | 82.42 | 54 |
| | cotton | | | | |
| 20D | Sebum/pigment on | 65.17 | 71.61 | 82.83 | 36 |
| | polyester/cotton | | | | |
| 10U | Curry on cotton | 72.20 | 88.99 | 90.29 | 93 |
| 10M | Motor oil/pigment | 62.77 | 72.35 | 76.31 | 71 |
| | on cotton | | | | |
| 90RM | Soot/mineral oil on | 59.44 | 69.96 | 75.63 | 65 |
| | cotton (IEC 456) | | | | |
| 90PB | Blood on cotton, | 60.71 | 81.45 | 78.69 | 108 |
| | aged (IEC 456) | | | | |
| 10N | Egg/pigment on | 61.32 | 81.21 | 80.98 | 101 |
| | cotton | | | | |
| 10R | Starch/pigment on | 66.97 | 80.81 | 82.51 | 89 |
| | cotton | | | | |
| 10PPM | Vegetable fat/milk/ | 61.50 | 74.06 | 76.86 | 82 |
| | pigment on cotton | | | | |
| 90MF | Cocoa on cotton, | 62.36 | 73.92 | 76.15 | 84 |
| | aged (IEC 456) | | | | |

From Table 2 it can be seen that the average regain of the cleaning performance of the virgin 1101 E particles due to the particle cleaning process ((BCP 3/1 L*−BCP2/1 L*)/(BCP 4/1 L*−BCP 2/1 L*)) is (74±7) %. Given the extreme nature of the particle pre-soiling procedure used, this shows the particle cleaning formulation of Table 1 to be a very efficient means of recovering particle cleaning performance, and thereby extending the useable lifetime of the polymeric particles.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1.-29. (canceled)

30. A method for the treatment of polymeric particles recovered after use in cleaning processes for soiled substrates, said method comprising treating said particles with a particle cleaning agent.

31. The method as claimed in claim 30, wherein said particle cleaning agent comprises at least one surfactant, wherein said surfactant optionally comprises at least one anionic, non-ionic, cationic, ampholytic, zwitterionic and/or semi-polar non-ionic surfactants.

32. The method as claimed in claim 30, wherein said particle cleaning agent comprises an aqueous liquor.

33. The method as claimed in claim 30, wherein said particle cleaning agent comprises at least one additional component selected from enzymes, oxidising agents/bleaches, biocides, stabilisers, wetting agents, solvents, builders, chelating agents, dispersants, enzyme stabilizers, catalytic materials, bleach activators, polymeric dispersing agents, anti-redeposition additives, perfumes, optical brighteners, clay soil removal agents, suds suppressors, dyes, structure elasticizing agents, carriers, hydrotropes, processing aids and/or pigments.

34. The method as claimed in claim 30, wherein said treatment is carried out at a temperature of from 5 to 95° C. and/or for a duration of from 5 to 120 minutes.

35. The method as claimed in claim 30, preceding claim wherein said treatment is carried out by sluicing a second chamber of a washing apparatus with clean water and cleaning said polymeric particles in a rotatably mounted cylindrical cage of said apparatus.

36. The method as claimed in claim 30, wherein said polymeric particles comprise particles of polyalkenes, polyesters, polyamides or polyurethanes, or their copolymers, wherein said polyamide particles optionally comprise nylon beads, wherein said nylon optionally comprises Nylon 6,6 homopolymer having a molecular weight in the region of from 5000 to 30000 Daltons.

37. The method as claimed in claim 30, wherein said polymeric particles are in the shape of spheres, cubes or cylinders, and said particles are solid or hollow, wherein said cylindrically shaped particles optionally have an average particle diameter in the region of from 1.0 to 6.0 mm and the length of said particles is optionally in the range of from 1.0 to 5.0 mm.

38. The method as claimed in claim 30, wherein said particles have an average mass in the region of from 1 to 50 mg.

39. The method as claimed in claim 30, wherein said polymeric particles comprise foamed or unfoamed polymeric materials and said polymers are either linear or crosslinked.

40. A method for cleaning a soiled substrate, said method comprising the steps of:
treating polymeric particles according to the method of claim 30; and
treating a moistened substrate with a formulation comprising a multiplicity of said treated polymeric particles.

41. A method as claimed in claim 40, wherein said substrate comprises a plastics material, leather, paper, cardboard, metal, glass, wood or a textile fibre or fabric which is a natural or synthetic fibre or fabric, wherein said natural or synthetic fibre or fabric optionally comprises cotton, nylon 6,6 or a polyester.

42. The method as claimed in claim 40, wherein said substrate is wetted by contact with mains or tap water, and said wetting optionally achieves a substrate to water ratio of between 1:0.1 to 1:5 w/w.

43. The method as claimed in claim 40, wherein the ratio of said particles to substrate is in the range of from 0.1:1 to 10:1 w/w.

44. The method as claimed in claim 40, wherein said treatment of a moistened substrate with a formulation comprising a multiplicity of said treated polymeric particles is carried out at a temperature of between 5° and 35° C. and/or for a duration of between 5 and 45 minutes.

45. The method as claimed in claim 40 used in a domestic or industrial cleaning process.

46. The method as claimed in claim 40 which comprises a batchwise process or continuous process.

47. A formulation for cleaning a soiled substrate, said formulation comprising a multiplicity of polymeric particles, wherein said particles have been treated with a particle cleaning agent.
